(19) United States
(12) Patent Application Publication
(10) Pub. No.: US 2010/0082682 A1
(43) Pub. Date: Apr. 1, 2010

(54) WEB CONTENTS ARCHIVE SYSTEM AND METHOD

(75) Inventor: Junji KINOSHITA, Sunnyvale, CA (US)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD., Tokyo (JP)

(21) Appl. No.: 12/237,029

(22) Filed: Sep. 24, 2008

(51) Int. Cl. G06F 17/30; G06F 7/00

(52) U.S. Cl. 707/784; 707/661

(57) ABSTRACT

System and method for archiving web content. The Intranet Web Contents Archive System incorporates one or more of the following modules: ID Management System for managing authentication and authorization information of each user; Data Archive Storage configured to directly access a web service and capture a web page using identification information of a certain user or a group; and a Web Service configured to communicate with ID management system and validate a request from the Data Archive Storage. In one implementation, the Data Archive Storage creates and stores additional information for the captured web page including the identification information of the user.

### FIELD OF THE INVENTION

This invention relates in general to data archive storage systems and web application systems and more specifically to methods and systems for archiving content provided to users by various web applications in an information technology (IT) system.

### DESCRIPTION OF THE RELATED ART

Various web-based applications and services have become extremely popular among Internet users. The main benefit of such applications is that the users do not need to install any special purpose software on their computers and use a simple Internet browser to communicate with a remote web-based service, which implements all necessary functionality. Thus, the user's client computer is used primarily as a terminal. One exemplary well-known use of the web-based applications is for communication between users.

Additionally, web-based applications have been becoming more and more popular in IT systems of many companies and organizations. Most of the corporate IT systems are designed to facilitate collaboration between employees and thereby improve employee productivity. Therefore, the content that the corporate web-based applications provide to the users contain valuable information on the business activities within the organization. This is especially true for companies, which rely heavily on the aforesaid web based applications in their day-to-day operations.

In general, companies and organizations preserve important electronic information using data archiving systems. This electronic information is preserved for compliance with regulatory requirements or to protect information assets of the companies. There are many storage solutions on the market, which can facilitate archiving of electronic documents and e-mails. On the other hand, archiving the content of the web-based application presents unique difficulties. Specifically, in most cases, the content of web-based application programs is dynamically created from various types of data resources and is provided to web clients by web-based application programs when the web clients access respective web services. This means that the content of web-based application programs, which will be referred to herein as web pages, is usually not stored in the form of document files.

A web page is composed of various types of data resources, which are usually managed using a database management system. Preserving the contents of the corresponding database tables is useful for the purpose of backup and recovery of the database data but not useful for purposes of data archiving. From the data archiving perspective, the archived data should be preserved in a human-readable form, because companies and organizations need to be able to utilize the archived information in the future without difficulty so that they can quickly locate their business records or information assets for the purposes of meeting regulation requirements, preparing for litigation, taking advantage of information assets, and the like.

As would be appreciated by those of skill in the art, there is an alternative way to archive web contents. This alternative method involves capturing web pages and storing the captured web pages substantially in the same form as they appear to web clients requesting them. Capturing web pages is widely used on the Internet. The web page capture on the Internet can be easily implemented chiefly because the vast majority of the information on the Internet is public and can be accessed by anyone. For example, an Internet Archive (www.archive.org) operates to capture publicly accessible web pages on the Internet and store them for subsequent retrieval.

However, it is more difficult to implement capture of web pages in the intranet systems of companies and organizations. This is because usually there are access control mechanisms for controlling access to web content in the internal organizational IT systems. From the data archiving perspective, it is important to preserve web content as it appears to a specific employee. However, it is usually unreasonable for companies and organizations to expect that their employees themselves capture all accessed web pages and securely store them into archive storage systems.

Therefore, there is a need for a data archive storage system that would successfully interoperate with access management systems and facilitate capture and archive storage of web content.

### SUMMARY OF THE INVENTION

The inventive methodology is directed to methods and systems that substantially obviate one or more of the above and other problems associated with conventional techniques for archiving content provided to users by various web applications in an information technology (IT) system.

In accordance with one aspect of an inventive methodology, there is provided a web content archive system including a web service configured to generate a web content in response to a request from one of multiple clients, an ID management system configured to manage user identification information; and a data archive storage configured to directly access the web service, capture and store the generated web content based on the user identification information. In the inventive system, the data archive storage is configured to authenticate with the web service using archive storage identification information and provide the user identification information to the web service. Furthermore, in response to an access request from the data archive storage, the web service communicates with the ID management system and validates the access request from the data archive storage based on the user identification information.

In accordance with another aspect of an inventive methodology, there is provided a web content archive system including a web service configured to generate a web content in response to a request from one of multiple clients, an ID management system configured to manage user identification information and archive storage identification information, and a data archive storage including a memory storing the user identification information and a web content information. In the inventive system, the data archive storage is configured to authenticate with the ID management system using the archive storage identification information; provide the web content information and the user identification information to the ID management system; receive a token from the ID management system; authenticate with the web service based on the user identification information and the token; and directly access the web service, capture and store the generated web content based on the user identification information. Furthermore, the web service validates an access request from the data archive storage based on the user identification information and the token.

In accordance with yet another aspect of an inventive methodology, there is provided a method performed by a web content archive system including a web service configured to generate a web content in response to a request from a client of a plurality of clients, an ID management system configured to manage user identification information; and a data archive storage. The inventive method involves: the data archive storage issuing an access request to the web service; the data archive storage authenticating with the web service using archive storage identification information; the data archive storage providing the user identification information to the web service; in response to the access request from the data archive storage, the web service communicating with the ID management system and validating the access request from the data archive storage based on the user identification information; upon successful validation in d., the data archive storage directly accessing the web service, capturing and storing the generated web content based on the user identification information.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary physical hardware and logical software architecture of an embodiment of the inventive concept.

FIG. 2 illustrates an exemplary embodiment of an Archive Configuration Table.

FIG. 3 illustrates an exemplary embodiment of a process for archiving contents of a web application.

FIG. 4 illustrates another exemplary embodiment of a process for archiving contents of a web application.

FIG. 5 illustrates yet another exemplary embodiment of a process for archiving contents of a web application.

FIG. 6 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

The Intranet Web Contents Archive System in implemented in accordance with an embodiment of the inventive concept incorporates one or more of the following modules: ID Management System for managing authentication and authorization information of each user; Data Archive Storage configured to directly access to a web service and capture a web page using identification information of a certain user or a group; and a Web Service configured to communicate with ID management system and validate a request from the Data Archive Storage. In an embodiment of the invention, the Data Archive Storage creates and stores additional information for the captured web page including the identification information of the user.

### First Exemplary Embodiment

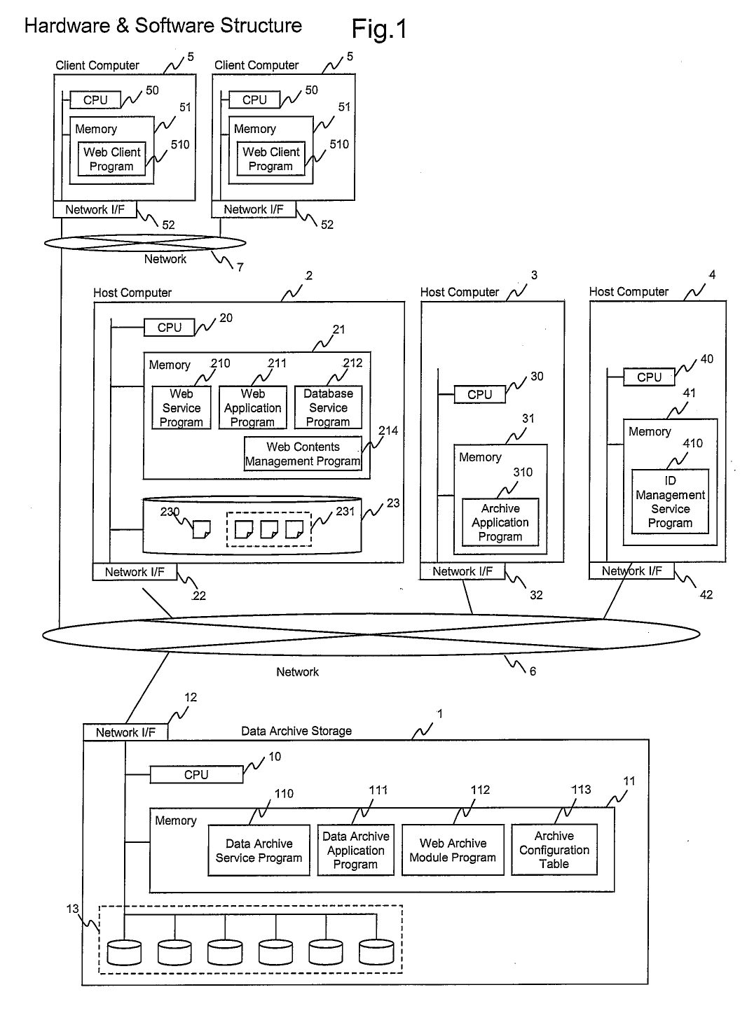

FIG. 1 illustrates an exemplary physical hardware and logical software architecture of an embodiment of the inventive concept. The overall system architecture incorporates at least one Data Archive Storage 1; one or more Host Computers 2, 3 and/or 4 and at least one Client Computer 5. The aforesaid components are interconnected through Network 6 and Network 7.

In general, the Data Archive Storage 1 is configured to reserve data for a certain period of time. An Archive Application Program 310 stored in the Memory 31 of the Host Computer 3 retrieves data from other Host Computers 2 and 4 or other storage system(s), optionally creates certain additional information based on the contents of the data (such as Meta data and the like), and places the data and, optionally, the additional information into the Data Archive Storage 1.

The data can be preserved in the Data Archive Storage 1 for various reasons. The data can be stored in the Data Archive Storage 1 for the purpose of preparing to possible future litigation. Organizations can also use the data stored in the Data Archive Storage 1 to meet various regulatory and compliance requirements. To meet the data preservation requirements of a specific client, the Data Archive Storage 1 may incorporate various data protection functions, such as WORM (Write Once Read Many) or data retention. The Data Archive Storage 1 can also generate certain additional information when it archives data, in order to help users leverage the data effectively. This function of the Data Archive Storage 1 is somewhat similar to the operation of the Archive Application Program 310, described above. For example, the Data Archive Storage 1 can create a Metadata and search index information based on the contents of each file being stored therein, in order to enable the users to easily locate the needed file from a large number of files.

In an embodiment of the inventive concept, the Data Archive Storage 1 is configured to archive contents provided by web-based applications on the Host Computer 2. The aforesaid content is archived in the form of human-readable web pages that a specific user sees on the web browser of his client computer. As would be appreciated by those of skill in the art, archived content is user-specific, because the content provided by the web-based applications to the users is based on the user-specific information determined by the user identity. The user identity, in turn, is verified using user authentication mechanisms using the user's credentials. To enable archiving of the user-specific information, the Data Archive Storage 1 incorporates the capabilities of both an archive application program and a web client application program, which usually reside on Host Computers or Client Computers.

In one embodiment of the inventive concept, the Data Archive Storage 1 operates to directly access the web service using its own credentials, provide certain user identification information to the web service, and capture web pages generated by the web service and preserve in the Data Archive Storage 1 web pages in the same form, as they appear to the user accessing them using a web browser. Additionally or alternatively, the Data Archive Storage 1 can use group identification information if companies and organizations manage groups. Each of these groups has several associated users and the corresponding users' identification is grouped within the ID management system. The Data Archive Storage 1 also creates additional information for the archived web pages, including the user or group identification information, which was used to capture the stored web pages. Web-based applications on the Host Computer 2 communicate with the ID Management Service Program 410 stored in the memory 41 of the Host Computer 4, and validate the access rights of the Data Archive Storage 1 and the user identification information used for capturing the web pages. In one embodiment of the invention, the Data Archive Storage 1 is configured perform the capturing and archiving operations for the same web page using different user identification information. This is done because the contents and the appearance of a specific web page, which is identified using a URL, can differ depending on the user identification information provided by the web clients.

As would be appreciated by those of skill in the art, capturing a web page is a commonly used technique to preserve web contents. Capturing a web page involves downloading the data included in a web page and, upon storing of the web page in the archive storage system, preserving the style and the format of the web page such that the captured web page appears like the web page viewed by the user.

With reference to FIG. 1, the Data Archive Storage 1 includes at least one CPU 10, at least one Memory 11 and at least one Network Interface 12, which is used for connecting the Data Archive Storage 1 to the Network 6. The Data Archive Storage 1 also incorporates one or more Logical Volumes 13. Each of the Logical Volumes 13 is comprised of multiple physical storage media such as HDDs (Hard Disk Drives), flash memory units, optical disks, tape drives, and the like. The Data Archive Storage 1 stores data in the Logical Volumes 13. The CPU 10 of the Data Archive Storage 1 is configured to execute various software programs, which are stored in the Memory 11. In addition to the software applications, the Memory 11 also stores various data and parameters used by the aforesaid software applications.

The Data Archive Service Program 110, stored in the memory 11, provides application programming interfaces for performing the data storage operations in the Data Archive Storage 1. In general, the Archive Application Program 310, executed by the CPU 30 of the Host Computer 3, retrieves data from the other Host Computers on the network or from other storage systems and stores the retrieved data in the Data Archive Storage 1 using the application programming interfaces provided by the Data Archive Service Program 110. The aforesaid interfaces can be implemented in a form of a proprietary interface or utilizing commonly used network filesystem mechanisms, such as NFS and CIFS, well known to persons of ordinary skill in the art. As stated above, the Archive Application Program 310 can also create certain additional information, such as metadata or search index information, based on the contents of files retrieved by the Archive Application Program 310 from the other Host Computers or other storage systems.

The Data Archive Application Program 111 implements the data archiving service for the Data Archive Storage 1. In one embodiment of the inventive concept, the Data Archive Application Program 111 invokes the Web Application Module Program 112 in order to perform archiving of the contents of web-based applications on the Host Computer 2 on a regular basis. In an embodiment of the invention, the Data Archive Application Program 111 may also be configured to receive data archive requests from the Web Contents Management Program 214 or Archive Application Program 310 and invoke the Web Archive Module Program 112 pursuant to the received requests. After the Web Archive Module Program 112 archives the captured web page contents, it can create and store additional information for the archived files, including the user identification information which was used to archive the files by Web Archive Module Program 112.

The Web Archive Module Program 112 provides web archiving service for the Data Archive Storage 1. It is invoked by the Data Archive Application Program 111 and is configured to access the web-based applications on the Host Computer 2 according to configuration parameters stored in the Archive Configuration Table 113. In one embodiment of the inventive concept, the Web Archive Module Program 112 requests web-based applications to authenticate its own identification information, and provides to the web-based applications identification information for a user or a user group to capture web pages which the user or each member of the user group sees, when he or she accesses the web-based application using the provided identification information.

The Archive Configuration Table 113 defines configuration parameters of the archiving service performed by the Data Archive Application Program 111 and the Web Archive Module Program 112. The parameters contained in this table are set by the administrator of the Data Archive Storage 1. In one embodiment of the inventive concept, the Web Archive Module Program 112 refers to this table in order to determine the location of the web pages for archiving, user identification information that will be used when the web pages are captured, and the interval information that defines the timing of the web page capture operation. This table can be updated time to time, such as to reflect changes in the company's or organization's data archiving policies.

The Host Computer 2 provides a web service to the employees of the company or organization. In various embodiments of the invention, the function of this web service may include, without limitation, enabling information sharing or knowledge management, providing employee collaboration tools, and the like. For example, in one embodiment of the invention, the employees can read, write, and share information with one another through the web service located on the Host Computer 2 using the Client Computers 5.

The Host Computer 2 includes at least one CPU 20, at least one Memory 21 and at least one Network interface 22, which is used for connecting the Host Computer 2 to the Network 6. The CPU 20 of the Host Computer 2 executes several software programs, which are stored in the Memory 21. In addition to the aforesaid programs, the Memory 21 stores the information used by these programs.

The Web Service Program 210 provides a web service interface enabling the other computers, including the Client Computers 5 and the Data Archive Storage 1, to use the web service. When the Web Service Program 210 receives a request to access a certain web application from the Client Computers 5 or the Data Archive Storage 1 via the web service interface, it invokes the equivalent Web Application Program 211. In general, a web page is identified using a URL.

In an embodiment of the invention, the Web Application Program 211 provides a web-based service that employees of companies or organizations use in their daily business activities. The Web Application Program 211 creates web pages based on the provided user identification information. When it receives a service request which consists of a URL and parameters, the Web Application Program 211 can authenticate the requestor based on its identification information. The requester can be either a user who is using one of the Client Computers 5, a member of a user group, or a Web Archive Module Program 112 of the Data Archive Storage 1. In an embodiment of the inventive concept, when it authenticates the requester, the Web Application Program 211 can use the ID Management Service Program 410 as a centralized authentication system. If the authentication process is successfully completed, the Web Application Program 211 can exchange requests and responses with the requester according to the protocol of the service implemented by the Web Application Program 211. The Web Application Program 211 can either provide static web pages or can dynamically compose web pages and send them back to the requestor in response to a request. Web pages can be composed of large amounts of information, which may include data stored in the Database File 230 and data contained in other Web Resource Files 231. To this end, the Web Application Program 211 can issue queries to the Database Service Program 212 to retrieve the necessary data from the Database File 230 or from the Web Resource Files 231. When the Web Application Program 211 composes web pages, it is configured to validate requestor's access rights using the ID Management Service Program 410 such that the requestor can access only the appropriate data, which it has a permission to access.

As a result, the same web page, which is provided to two requesters, can have different contents and different appearance based on identification information of the requesters, even if the URL is the same. In one embodiment, the Web Application Program 211 first authenticates the requests made by the Web Archive Module Program 112 using its own identification information. In addition, the Web Archive Module Program 112 provides to the Web Application Program 211 certain user identification information in order to capture web pages with the user's access rights.

The Database Service Program 212 implements a database service interface. In an embodiment of the invention, the Web Application Program 211 is configured to manage various types of data, which may include data used for composing web pages, using the aforesaid database. The use of the database by the Web Application Program 211 enables easy search and retrieval of the stored data.

The Web Contents Management Program 214 implements an interface that enables users or administrators to create or modify web contents. In some cases, the contents of web service can be updated through the Web Application Program 211 as well as the Web Contents Management Program 214. In one embodiment of the inventive concept, the Web Contents Management Program 214 can notify the Data Archive Application Program 111 on the Data Archive Storage 1 that the web content has been updated, such that the Data Archive Storage 1 can perform the archiving operation on the modified web contents in a timely manner. The Database File 230 stores database data managed by the Database Service Program 212.

The Web Resource Files 231 contain various types of data, such as text, images, and the like. These data can be used to compose web pages.

The Host Computer 3 is configured to provide the data archiving service. In general, the Archive Application Program 310 on the Host Computer 3 retrieves data from other computers or storage systems and places the retrieved data into the Data Archive Storage 1.

The Host Computer 3 includes at least one CPU 30, at least one Memory 31 and at least one Network Interface 32, which is used to connect the Host Computer 3 the to Network 6. The CPU 30 of the Host Computer 3 executes various software application programs. These programs themselves as well as the information used by these programs are stored in Memory 31.

The Archive Application Program 310 implements a data archiving service. Generally, the Archive Application Program 310 retrieves files stored in other Host Computers or storage systems and archives them using the Data Archive Storage 1. It may also be configured to create additional information for the archived files. In one embodiment, the Archive Application Program 310 requests the Data Archive Storage 1 to perform the web contents archiving operation on a regular basis. The content for archiving may be provided by the Web Service Program of the Host Computer 2.

The Host Computer 4 is configured to manage identification information for both the users of the web service who use the Client Computers 5 to access the later and the programs executed by the Data Archive Storage 1. The Host Computer 4 incorporates at least one CPU 40, at least one Memory 41 and at least one Network Interface 42, which is used for connecting the Host Computer 4 to the Network 6. The CPU 40 of the Host Computer 4 executes various software application programs. These programs themselves as well as the information used by these programs are stored in the Memory 41.

The ID Management Service Program 410 implements an interface, which enables an administrator to manage the identification information of end users, groups, programs, and devices. In an embodiment of the inventive concept, the ID Management Service Program 410 also provides a centralized authentication service enabling each user, program, and device to authenticate themselves to one another using this service. In addition to the aforesaid authentication service, the ID Management Service Program 410 can also provide a centralized authorization service enabling each user, group, program, and device to obtain information of the appropriate scope.

In one embodiment of the inventive concept, the Client Computers 5 are utilized by employees of a company or organization in their business activities. Each employee has access to and can use web services provided by the Host Computer 2 using these Client Computers 5.

Each of the Client Computers 5 incorporates at least one CPU 50, at least one Memory 51 and at least one Network Interface 52, which is used for connecting the Client Computer 5 to the Network 7. The CPU 50 of the Client Computer 5 executes various software application programs. These programs themselves as well as the information used by these programs are stored in the Memory 51 of the Client Computer 5.

The Web Client Program 510 implements an interface, which enables the user to access the web service. In one embodiment of the inventive concept, the user accesses the Web Application Program 211 via the Web Service Program 210 on the Host Computer 2 using the Web Client Program 510. If necessary, the user authentication operation is performed and the user sees web pages returned in response to his or her service requests using the Web Client Program 510.

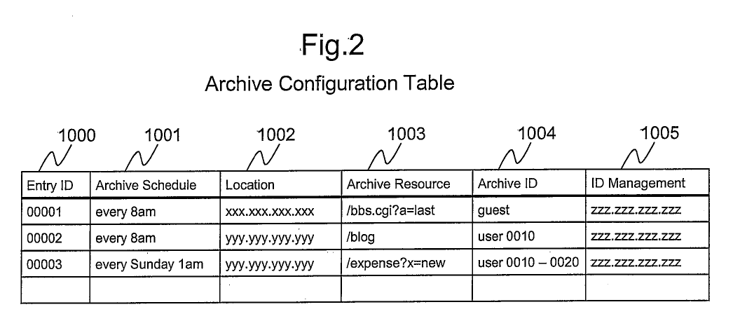

FIG. 2 illustrates an exemplary data structure of the Archive Configuration Table 113.

The Entry ID 1000 provides unique identification information for each row in the table.

The Archive Schedule 1001 indicates a particular time or time intervals when the Data Archive Application Program 111 performs the data archiving operations.

The Location 1002 provides unique network identification information for each computer, such as an IP address of one of the Host Computers. The Web Archive Module Program 112 refers to this information to access the web service on the Host Computer 2.

The Archive Resource 1003 provides unique identification information of the data on a computer identified by the Location 1002.

The Archive ID 1004 provides unique identification information of each user. The Web Archive Module Program 112 uses this identification information when it tries to capture web pages such that the captured web pages have the same appearance as the ones presented to the user having the same identity information.

The ID Management 1005 provides network identification information of a Host Computer wherein the ID Management Service Program 410 managing the Archive ID 1004 is executing.

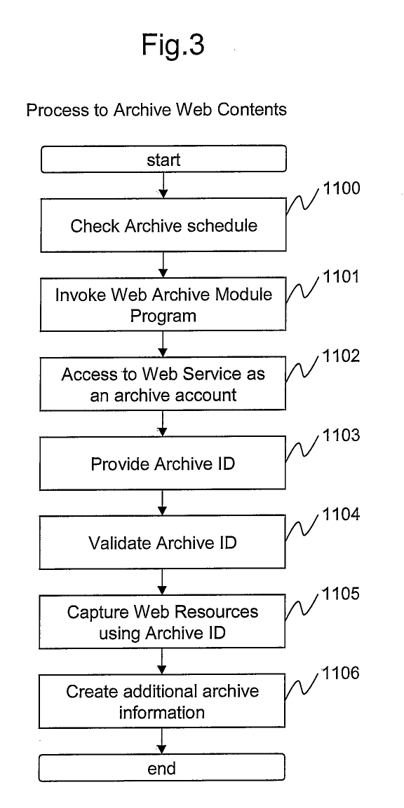

FIG. 3 illustrates an exemplary embodiment of a process for archiving web contents. In the shown exemplary embodiment, the Data Archive Storage 1 archives the web content on a regular basis.

Step 1100: The Data Archive Application Program 111 checks the Archive Schedule 1001 defined in the Archive Configuration Table 113 to determine if the data archive time has approached. If there are any entries that should be archived, the operation proceeds to Step 1101. Otherwise, the process waits for the scheduled time.

Step 1101: The Data Archive Application Program 111 invokes the Web Archive Module Program 112 and provides it with the Entry ID 1000 of the entry which should be processed.

Step 1102: The Web Archive Module Program 112 refers to the entry identified by the Entry ID 1000 in the Archive Configuration Table 113 and determines the network identification information of the Host Computer 2 where the corresponding web resources are located. The Web Archive Module Program 112 accesses the Web Application Program 211 via the Web Service Program 210 on the Host Computer 2, and requests authentication using its own identification information. For purposes of authentication, the Web Archive Module Program 112 can use various types of secret information or credentials such as a password, a certificate, and the like. If the authentication is successful, the process proceeds to Step 1103. Otherwise, the Web Application Program 211 discards the request.

Step 1103: After the Web Archive Module Program 112 successfully authenticates itself to the Web Application Program 211, the Web Archive Module Program 112 provides to the Web Application Program 211 the Archive ID 1004 from the Archive Configuration Table 113 and the corresponding Archive Resource 1003, which identify the web resources that should be archived.

Step 1104: The Web Application Program 211 performs a request authorization for access to the web resources for a provided Archive ID 1004 using the ID Management Service Program 410. If the request associated with the Archive ID 1004 is successfully authorized for access to the Archive Resource 1003, the process proceeds to the Step 1105. Otherwise, the Web Application Program 211 rejects the request.

Step 1105: The Web Application Program 211 dynamically creates web pages from the data stored in the database or in the web resource files, which can be accessed by the user having identity information corresponding to the provided Archive ID 1004, and sends the generated web pages back to the Web Archive Module Program 112. The Web Archive Module Program 112 receives and captures the web pages in the same form as they appear to the user having the same identity information.

Step 1106: The Data Archive Application Program 111 creates and stores additional information for the captured web pages. This additional information may include the Archive ID 1004 information, which is used to capture the web pages.

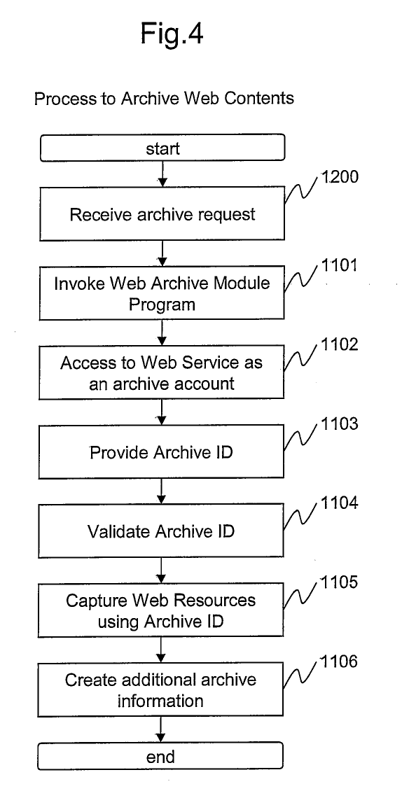

FIG. 4 illustrates an exemplary embodiment of a process for archiving web content. In this example, the Data Archive Storage 1 archives the web content in response to archiving requests received from the Web Contents Management Program 214 or the Archive Application Program 310.

Step 1200: The Data Archive Application Program 111 receives a request from a requestor to archive web resources. The requester can be either the Web Contents Management Program 214 or the Archive Application Program 310. The requester specifies the location information of a Host Computer 2, the resource name information, which identifies the web resource that should be archived, and the user identification information, which are defined in the Archive Configuration Table 113.

Step 1201: The Data Archive Application Program 111 invokes the Web Archive Module Program 112 and provides it with the necessary information, which was received from the requester in step 1200.

Step 1202: The Web Archive Module Program 112 accesses the Web Application Program 211 via the Web Service Program 210 on the Host Computer 2, and requests authentication using its own identification information. The Web Archive Module Program 112 can use various kinds of secret information or credentials, including, without limitation, a password, a certification, and the like. If the authentication succeeds, the process proceeds to Step 1103. Otherwise, the Web Application Program 211 discards the received request.

Step 1203: After the Web Archive Module Program 112 successfully authenticates itself to the Web Application Program 211, the Web Archive Module Program 112 provides the Archive ID and the Archive Resource, which identifies the web resource that should be archived to the Web Application Program 211.

Step 1204: The Web Application Program 211 authorizes access to the web resource corresponding to the provided Archive ID using the ID Management Service Program. If the Archive ID is successfully authorized to access the Archive Resource, the process proceeds to Step 1105. Otherwise, the request is rejected.

Step 1205: The Web Application Program 211 dynamically creates web pages from the data stored in the database or the web resource files, which are permitted to be accessed by a user associated with the provided Archive ID. After that, the Web Application Program 211 sends the created web pages back to the Web Archive Module Program 112 as results. The Web Archive Module Program 112 captures the received web pages in such a way that they are stored in the same format as they appear to a user associated with the provided Archive ID.

Step 1206: The Data Archive Application Program 111 creates additional information for the captured web pages, which may include the Archive ID information 1004, which corresponds to the user associated with the provided Archive ID used to capture the web pages.

### Second Exemplary Embodiment

In the first exemplary embodiment of the inventive concept described above, the Data Archive Storage 1 accesses the web service located on the Host Computer 2 using its own credentials and then provides a user or a group identification information to web services. In a second exemplary embodiment of the inventive concept, the Data Archive Storage 1 accesses the web service disposed on the Host Computer 2 using user's or group's credentials.

The physical hardware and logical software architecture of the second embodiment can be substantially similar to the corresponding architecture of the first exemplary embodiment, which is shown in FIG. 1. The data structures of the second exemplary embodiment are also substantially similar to those of the first exemplary embodiment.

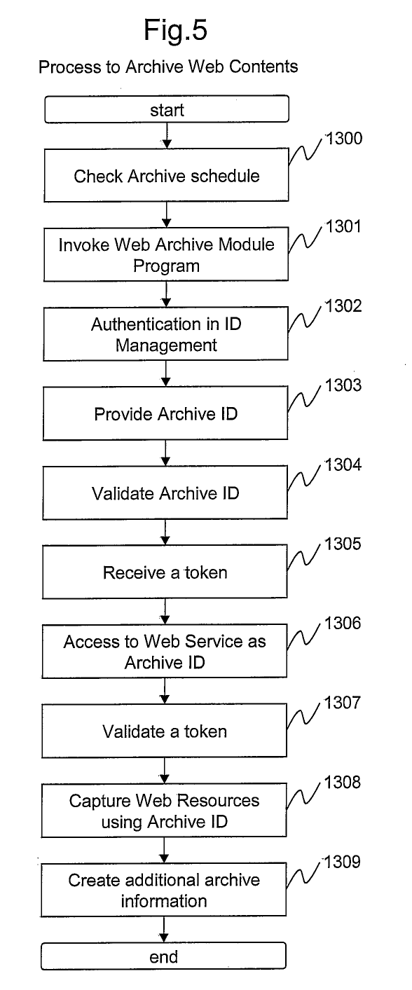

FIG. 5 shows an exemplary embodiment of a process for archiving the web content. In this example, the Data Archive Storage 1 archives the web content on a regular basis.

Step 1300: The Data Archive Application Program 111 checks the Archive Schedule 1001 specified in the Archive Configuration Table 113 to determine whether the file for archiving the data has approached. If there are any entries that should be archived, the operation proceeds to Step 1101. Otherwise, the process waits for the scheduled archive time.

Step 1301: The Data Archive Application Program 111 invokes the Web Archive Module Program 112 and provides it with the Entry ID 1000 of the entry which should be processed.

Step 1302: The Web Archive Module Program 112 refers to the entry identified by the Entry ID 1000 in the Archive Configuration Table 113 and determines the network identification information of the Host Computer 4, where the user identification information is managed for the web resources. The Web Archive Module Program 112 then sends a request to the ID Management Service Program 410 on the Host Computer 4, and requests authentication using its own identification information. The Web Archive Module Program 112 can use various kinds of secret information or credentials such as a password, a certification, and the like. If the authentication is successful, the operation proceeds to the Step 1103. Otherwise, the ID Management Service Program 410 discards the request.

Step 1303: After the Web Archive Module Program 112 successfully authenticates itself to the ID Management Service Program 410, the Web Archive Module Program 112 provides the Archive ID 1004 specified in the Archive Configuration Table 113 and the Archive Resource 1003, which identifies web resources that should be archived to the Data Archive Storage 1.

Step 1304: The ID Management Service Program 410 authorizes the access to the web resource associated with the provided Archive ID 1004. If the Archive ID 1004 is successfully authorized to access the Archive Resource 1003, the operation proceeds to Step 1305. Otherwise, the request is rejected.

Step 1305: The ID Management Service Program 410 provides the Web Archive Module Program 112 with a token, which enables the Web Archive Module Program 112 to access the web resources on the Host Computer 2 using the Archive ID 1004. In an embodiment of the invention, the token can include the Archive ID 1004 certified by the ID Management Service Program 410, such as a digitally signed Archive ID, encrypted Archive ID using a shared secret information, and the like. The present invention is not limited to a specific token format or content.

Step 1306: The Web Archive Module Program 112 accesses the Web Application Program 211 via the Web Service Program 210 on the Host Computer 2, and requests authentication using the token that was received in the Step 1305.

Step 1307: The Web Application Program 211 validates the token provided in Step 1306. As it is well known to persons of skill in the art, there are various ways of validating the token. In one example, the Web Application Program 211 validates the token using a secret key shared with the ID Management Service Program 410, which is registered in advance.

Step 1308: The Web Application Program 211 dynamically creates web pages from the data stored in the database or web resource files, which are permitted to be accessed by a user associated with the provided Archive ID 1004. After that, the Web Application Program 211 sends the created web pages back to the Web Archive Module Program 112 as results. The Web Archive Module Program 112 captures the received web pages in such a way that they are stored in the same format as they appear to a user associated with the provided Archive ID.

Step 1309: The Data Archive Application Program 111 creates additional information for the captured web pages, which may include the Archive ID information 1004, which corresponds to the user associated with the provided Archive ID used to capture the web pages.

### Exemplary Computer Platform

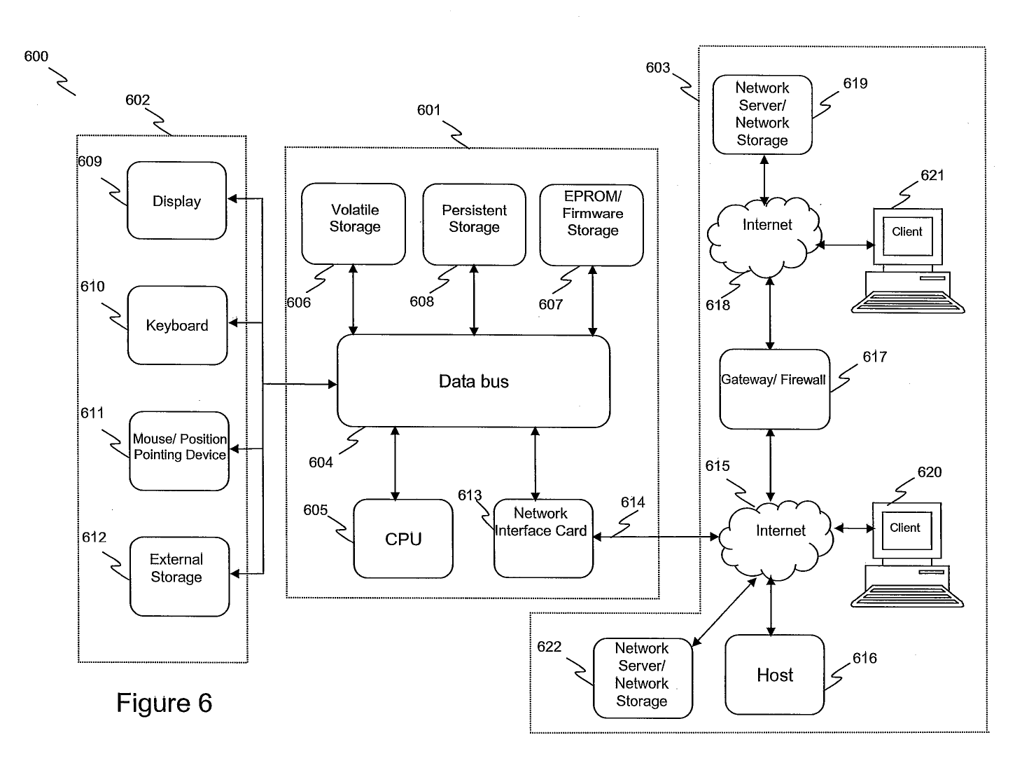

FIG. 6 is a block diagram that illustrates an embodiment of a computer/server system 600 upon which an embodiment of the inventive methodology may be implemented. The system 600 includes a computer/server platform 601, peripheral devices 602 and network resources 603.

The computer platform 601 may include a data bus 604 or other communication mechanism for communicating information across and among various parts of the computer platform 601, and a processor 605 coupled with bus 601 for processing information and performing other computational and control tasks. Computer platform 601 also includes a volatile storage 606, such as a random access memory (RAM) or other dynamic storage device, coupled to bus 604 for storing various information as well as instructions to be executed by processor 605. The volatile storage 606 also may be used for storing temporary variables or other intermediate information during execution of instructions by processor 605. Computer platform 601 may further include a read only memory (ROM or EPROM) 607 or other static storage device coupled to bus 604 for storing static information and instructions for processor 605, such as basic input-output system (BIOS), as well as various system configuration parameters. A persistent storage device 608, such as a magnetic disk, optical disk, or solid-state flash memory device is provided and coupled to bus 601 for storing information and instructions.

Computer platform 601 may be coupled via bus 604 to a display 609, such as a cathode ray tube (CRT), plasma display, or a liquid crystal display (LCD), for displaying information to a system administrator or user of the computer platform 601. An input device 610, including alphanumeric and other keys, is coupled to bus 601 for communicating information and command selections to processor 605. Another type of user input device is cursor control device 611, such as a mouse, a trackball, or cursor direction keys for communicating direction information and command selections to processor 604 and for controlling cursor movement on display 609. This input device typically has two degrees of freedom in two axes, a first axis (e.g., x) and a second axis (e.g., y), that allows the device to specify positions in a plane.

An external storage device 612 may be coupled to the computer platform 601 via bus 604 to provide an extra or removable storage capacity for the computer platform 601. In an embodiment of the computer system 600, the external removable storage device 612 may be used to facilitate exchange of data with other computer systems.

The invention is related to the use of computer system 600 for implementing the techniques described herein. In an embodiment, the inventive system may reside on a machine such as computer platform 601. According to one embodiment of the invention, the techniques described herein are performed by computer system 600 in response to processor 605 executing one or more sequences of one or more instructions contained in the volatile memory 606. Such instructions may be read into volatile memory 606 from another computer-readable medium, such as persistent storage device 608. Execution of the sequences of instructions contained in the volatile memory 606 causes processor 605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 605 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 608. Volatile media includes dynamic memory, such as volatile storage 606. Transmission media includes coaxial cables, copper wire and fiber optics, including the wires that comprise data bus 604. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 605 for execution. For example, the instructions may initially be carried on a magnetic disk from a remote computer. Alternatively, a remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on the data bus 604. The bus 604 carries the data to the volatile storage 606, from which processor 605 retrieves and executes the instructions. The instructions received by the volatile memory 606 may optionally be stored on persistent storage device 608 either before or after execution by processor 605. The instructions may also be downloaded into the computer platform 601 via Internet using a variety of network data communication protocols well known in the art.

The computer platform 601 also includes a communication interface, such as network interface card 613 coupled to the data bus 604. Communication interface 613 provides a two-way data communication coupling to a network link 614 that is coupled to a local network 615. For example, communication interface 613 may be an integrated services digital network (ISDN) card or a modem to provide a data communication connection to a corresponding type of telephone line. As another example, communication interface 613 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 613 sends and receives electrical, electromagnetic or optical signals that carry digital data streams representing various types of information.

Network link 613 typically provides data communication through one or more networks to other network resources. For example, network link 614 may provide a connection through local network 615 to a host computer 616, or a network storage/server 617. Additionally or alternatively, the network link 613 may connect through gateway/firewall 617 to the wide-area or global network 618, such as an Internet. Thus, the computer platform 601 can access network resources located anywhere on the Internet 618, such as a remote network storage/server 619. On the other hand, the computer platform 601 may also be accessed by clients located anywhere on the local area network 615 and/or the Internet 618. The network clients 620 and 621 may themselves be implemented based on the computer platform similar to the platform 601.

Local network 615 and the Internet 618 both use electrical, electromagnetic or optical signals that carry digital data streams. The signals through the various networks and the signals on network link 614 and through communication interface 613, which carry the digital data to and from computer platform 601, are exemplary forms of carrier waves transporting the information.

Computer platform 601 can send messages and receive data, including program code, through the variety of network(s) including Internet 618 and LAN 615, network link 614 and communication interface 613. In the Internet example, when the system 601 acts as a network server, it might transmit a requested code or data for an application program running on client(s) 620 and/or 621 through Internet 618, gateway/firewall 617, local area network 615 and communication interface 613. Similarly, it may receive code from other network resources.

The received code may be executed by processor 605 as it is received, and/or stored in persistent or volatile storage devices 608 and 606, respectively, or other non-volatile storage for later execution. In this manner, computer system 601 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized systems for archiving web resources. It is intended that the specification and examples be considered as exemplary only, with a true scope and spirit of the invention being indicated by the following claims.

What is claimed is:

1. A web content archive system comprising:
a. a web service operable to generate a web content in response to a request from a client of a plurality of clients;
b. an identification (ID) management system operable to manage user identification information; and
c. a data archive storage operable to directly access the web service, capture and store the generated web content based on the user identification information; wherein the data archive storage is operable to authenticate with the web service using archive storage identification information and provide the user identification information to the web service and wherein in response to an access request from the data archive storage, the web service is operable to communicate with the ID management system and validate the access request from the data archive storage based on the user identification information.

2. The system of claim 1, wherein the data archive storage is operable to create and store additional information associated with the captured web content, the additional information comprising the user identification information.

3. The system of claim 1, wherein validating the access request from the data archive storage comprises authorizing access to the web content associated with the user identification information.

4. The system of claim 1, wherein the generated web content is captured in a format substantially similar to appearance of the generated web content on a display device of the client.

5. The system of claim 1, wherein the data archive storage comprises a data archive application module operable to automatically cause the data archive storage to capture and store the generated web content on a periodic basis based on archive schedule information.

6. The system of claim 1, wherein the data archive storage captures and stores the generated web content based on a request from a requestor.

7. The system of claim 1, wherein the data archive storage comprises archive configuration information, the archive configuration information comprising web service location information, web content information, the user identification information and ID management system location information.

8. The system of claim 7, wherein the archive configuration information further comprises archive schedule information.

9. A web content archive system comprising:
a. a web service operable to generate a web content in response to a request from a client of a plurality of clients;
b. an identification (ID) management system operable to manage user identification information and archive storage identification information; and
c. a data archive storage comprising a memory storing the user identification information and a web content information; the data archive storage operable to authenticate with the ID management system using the archive storage identification information; provide the web content information and the user identification information to the ID management system; receive a token from the ID management system; authenticate with the web service based on the user identification information and the token; and directly access the web service, capture and store the generated web content based on the user identification information; wherein the web service is operable to validate an access request from the data archive storage based on the user identification information and the token.

10. The system of claim 9, wherein the data archive storage is operable to create and store additional information associated with the captured web content, the additional information comprising the user identification information.

11. The system of claim 9, wherein validating the access request from the data archive storage comprises authorizing access to the web content associated with the user identification information and wherein the token comprises the user identification information certified by the ID management system.

12. The system of claim 9, wherein the generated web content is captured in a format substantially similar to appearance of the generated web content on a display device of the client.

13. The system of claim 9, wherein the data archive storage comprises a data archive application module operable to automatically cause the data archive storage to capture and store the generated web content on a periodic basis based on archive schedule information.

14. The system of claim 9, wherein the data archive storage captures and stores the generated web content based on a request from a requestor.

15. The system of claim 9, wherein the data archive storage comprises archive configuration information, the archive configuration information comprising web service location information, the web content information, the user identification information and ID management system location information.

16. The system of claim 15, wherein the archive configuration information further comprises archive schedule information.

17. A method performed by a web content archive system comprising a web service operable to generate a web content in response to a request from a client of a plurality of clients; an identification (ID) management system operable to manage user identification information; and a data archive storage, the method comprising:
a. the data archive storage issuing an access request to the web service;
b. the data archive storage authenticating with the web service using archive storage identification information;
c. the data archive storage providing the user identification information to the web service;
d. in response to the access request from the data archive storage, the web service communicating with the ID management system and validating the access request from the data archive storage based on the user identification information;
e. upon successful validation in d., the data archive storage directly accessing the web service, capturing and storing the generated web content based on the user identification information.

18. The method of claim 17, further comprising the data archive storage creating and storing additional information associated with the captured web content, the additional information comprising the user identification information.

19. The method of claim 17, wherein the generated web content is captured in a format substantially similar to appearance of the generated web content on a display device of the client.

20. The method of claim 17, wherein the access request causing the capture and storage of the web content is issued on a periodic basis based on archive schedule information.
